(19) United States
(12) Patent Application Publication
(10) Pub. No.: US 2005/0270298 A1
(43) Pub. Date: Dec. 8, 2005

(54) Daughter card approach to employing multiple graphics cards within a system

(75) Inventor: Scott A. Thieret, Nashua, NH (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MERCURY COMPUTER SYSTEMS, INC., Chelmsford, MA (US)

(21) Appl. No.: 11/129,123

(22) Filed: May 13, 2005

Related U.S. Application Data
(60) Provisional application No. 60/571,047, filed on May 14, 2004.

(51) Int. Cl. G06F 15/16

(52) U.S. Cl. 345/502

(57) ABSTRACT

The invention provides, in one aspect, a digital data processor including a motherboard comprising a printed circuit board having disposed thereon (a) a central processing unit and one or more associated memories, and (b) a primary slot adapted to provide signal coupling compatible with the PCI-Express industry standard. The digital data processor further includes a graphics interface device that is mounted in the primary slot and that, as a consequence, is in mechanical and signal coupling with the motherboard. That graphics interface device, itself, has a plurality of further slots, each of which is adapted to provide signal coupling compatible with the PCI-Express industry standard.

This application claims the benefit of priority of U.S. Patent Application Ser. No. 60/571,047, filed May 14, 2004, and entitled “A Daughter Card Approach to Employing Multiple Graphics Cards within a System,” the teachings of which are incorporated herein by reference.

### BACKGROUND OF THE INVENTION

The invention pertains to digital data processing and, more particularly, improved methods and apparatus for interfacing graphics processing units (GPUs) within a digital data processor. The invention has application, by way of non-limiting example, in increasing the number of GPUs connected to a motherboard.

By way of background, GPUs have been increasing both in functionality and processing speed at a rapid rate. With the inclusion of general purpose programmability, they are also being employed to perform non-graphical applications. While they are potent compute engines, many algorithms require more computational resources, memory and memory bandwidth than provided by a single GPU. In addition, visualization systems may require either more rendering capability or the ability to drive more displays than a single graphics card affords.

Though use of multiple graphics processors has been proposed, e.g., within a single digital data processor, none of these solutions has yet proven satisfactory for wide, low-cost implementation. Examples of this include U.S. Pat. No. 6,747,654, assigned to ATI International, suggesting use of parallel graphics processors that utilize event completion signaling to stall rendering by a graphics processor that has completed a current frame. That patent fails to disclose the specifics of an interconnect between the graphics processors and the host they serve. A further example is U.S. Pat. No. 6,377,266, assigned to 3DLabs, disclosing use of multiple graphics rendering processors connected to each other over a common system bus, e.g., a PCI bus. That patent fails to disclose an architecture that can be readily implemented in existing digital data processing systems, e.g., workstations.

An object of the invention is to provide improved methods and apparatus for digital data processing.

A further object is to provide such methods and apparatus that facilitate interfacing with GPUs within a digital data processor.

Yet a still further object is to provide such methods and apparatus as can be readily implemented in existing and future digital data processing systems

Still yet, a further object is to provide such methods and apparatus as can be implemented at low cost, using existing technologies.

### SUMMARY OF THE INVENTION

The foregoing are among the objects attained by the invention, which provides, in one aspect, a digital data processor including a motherboard comprising a printed circuit board having disposed thereon (a) one or more central processing units and one or more associated memories, and (b) a primary slot adapted to provide signal coupling compatible with the PCI-Express industry standard. The digital data processor further includes a graphics interface device that is mounted in the primary slot and that, as a consequence, is in mechanical and signal coupling with the motherboard. That graphics interface device, itself, has a plurality of further slots, each of which is adapted to provide signal coupling compatible with the PCI-Express industry standard.

Related aspects of the invention provide a digital data processor as described above in which at least one graphics device is mounted in, and in mechanical and signal coupling with, a respective one of the further slots on the graphics interface device. Further related aspects of the invention provide such a digital data processor in which a plurality of graphics devices are mounted in, and in mechanical and signal coupling with, respective ones of the further slots on the graphics interface device.

Related aspects of the invention provide a digital data processor as described above in which one or more of the devices mounted in the further slots of the graphics interface device are graphics processing units (GPUs). Further related aspects of the invention provide such a digital data processor wherein the primary slot, in which the graphics interface device is mounted, is intended for mounting of a single PCI-Express device, such as a GPU.

Further aspects of the invention provide a digital data processor as described above in which the graphics interface device comprises a daughtercard (e.g., a printed circuit board) on which the further slots are disposed. The daughtercard is, according to some aspects of the invention, disposed substantially parallel to the motherboard when mounted in the primary slot. In alternative aspects of the invention, the daughtercard is disposed substantially normal to the motherboard and the graphics devices are disposed substantially parallel to the motherboard, when the daughtercard is mounted in the primary slot and the graphics devices are mounted in the daughtercard.

The invention provides, in still other aspects, a digital data processor as described above in which the primary slot is adapted to provide (a) signal coupling over N channels, each providing a separate respective point-to-point serial connection between the motherboard and the graphics interface device, and (b) mechanical coupling sufficiently sized for N corresponding conductor sets (or “lanes”), each providing an electrical signaling pathway for the serial connection of a respective one of those channels. According to related aspects of the invention, at least one of those N channels (and, typically, all of them) provides a two-way serial connection between the graphics interface device and the CPU and/or one of its associated memories.

Related aspects of the invention provide such a digital data processor in which the graphics interface device comprises one or more bridges or switches (collectively, “switches”) that provide signal coupling between subsets of the N channels received from the primary slot and respective ones of the further slots on the graphics interface device. Further related aspects of the invention provide such a digital data processor in which those further slots provide mechanical coupling sufficiently sized for all N conductor sets, yet, provide electrical coupling for only the respective subsets of the channels for which signal coupling is provided by the switches.

By way of example, in one embodiment of the invention, the motherboard has a single sixteen-lane (16x) PCI-Express primary slot and the graphics interface device, or daughtercard, has four or more slots. Switches on the graphics interface device can be configured to support a multitude of different configurations, e.g., dual 8x, where two of the slots on the daughtercard are configured for signal coupling on eight lanes (8x); quad 4x, where four slots on the daughtercard are configured for signal coupling on four lanes (4x); eight 2x, where eight slots on the daughtercard are configured for signal coupling on two lanes (2x); or even sixteen 1x, where sixteen slots on the daughtercard are configured for signal coupling on one lane (1x). The switches can also support unbalanced configurations, e.g., where some slots on the daughtercard are coupled on more lanes than others, e.g., one 8x and dual 4x.

Further related aspects of the invention provide a digital data processor as described above in which signal coupling to one or more of the further slots on the graphics interface device is supported passively (e.g., without bridges and/or switches) by direct electrical signal pathways (e.g., electrical wiring, pins, solder pads and/or printed circuit board conductive vias) for respective subsets of the N channels received from the primary slot.

Still other related aspects of the invention provide a digital data processor as described above in which the subsets of channels over which signaling is provided to the further slots are of equal bandwidth. In alternative aspects of the invention, those subsets are not of equal bandwidth.

Yet still other aspects of the invention provide a digital data processor as described above in which the graphics devices are housed and/or cooled separately from the motherboard.

Still yet further aspects of the invention provide a digital data processor as described above in which devices other than, or in addition to, GPUs are mounted in the further slots of the graphics interface device.

Other aspects of the invention provide a graphics interface device as described in the various aspects above.

Still yet other aspects of the invention provide methods of operating a digital data process and/or a graphics interface device as described in the various aspects above.

### BRIEF DESCRIPTION OF THE DRAWINGS

A more complete understanding of the invention may be attained by reference to the drawings, in which:

FIG. 1 depicts a digital data processor in accord with one practice of the invention in which the graphics interface device is disposed parallel to the motherboard;

FIG. 2 depicts digital data processor in accord with one practice of the invention in which the graphics interface device is disposed normal to the motherboard;

FIG. 3 depicts a digital data processor in accord with one practice of the invention in which the graphics interface device is housed and/or cooled separately from the motherboard.

### DETAILED DESCRIPTION OF THE ILLUSTRATED EMBODIMENT

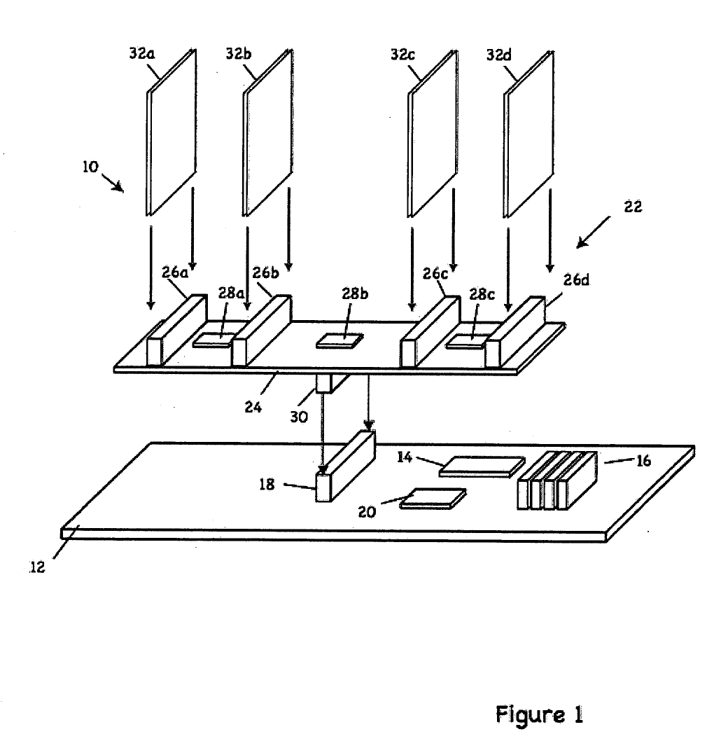

FIG. 1 depicts a digital data processor 10 according to one practice of the invention. This includes a motherboard 12 of the type commercially available in the marketplace, e.g., a commodity motherboard, of the type having a CPU 14, associated memory 16, graphics card slot 18, and other components (here, represented by element 20), all of the type known and/or commonly used in the art. These elements 12-18 are configured and operated in the conventional manner known in the art, as adapted in accord with the teachings hereof. Though only one CPU 14 is shown, it will be appreciated that additional CPUs (as well as other processing elements, instead or in addition) may be provided on the board 12, again, as is known and/or common in the art.

Although embodiments of the invention described herein utilize a motherboard 12, it will be appreciated that the teachings hereof are equally applicable to other digital data processing boards (e.g., daughtercards, input/output modules, and so forth), digital data devices, and the like, equipped with one or more graphics card slots 18 compatible with the PCI-Express industry standard. Moreover, while the embodiments described herein utilize a single graphics card slot 18, it will be appreciated that the teachings hereof may be applied to multiple such slots in boards, devices, and the like, so equipped.

Illustrated graphics board slot 18 comprises a connector (e.g., a card edge socket) of the type conventional to, or otherwise known in, the art that is adapted to provide “signal coupling” (i.e., to support communications) compatible with the PCI-Express industry standard. That industry standard is detailed in PCI-Express Base Specification 1.1, PCI-Express Card Electromechanical Specification 1.1, PCI-Express Mini Card Electromechanical Specification 1.1, PCIe Express Module Electromechanical Spec 1.0, PCI-Express™ x16 Graphics 150W-ATX Specification 1.0, PCIe to PCI/PCI-X Bridge Spec 1.0, as well as prior versions thereof, all published by and available from the Peripheral Component Interconnect Special Interest Group (PCI-SIG), e.g., under Product Codes listed below or otherwise, the teachings of all of which are incorporated herein by reference:

| Prod Code | Publication Name |
|---|---|
| NR29 | PCI-Express x16 Graphics 150W-ATX Specification 1.0 |
| NR28 | PCI-Express Mini Card Specification 1.1 |
| NR27 | PCI-Express to PCI/PCI-X Bridge Specification Revision 1.0 |
| NR26 | PCI-X 2.0a Protocol and Electrical Specification |
| NR25 | PCI-Express Specification 1.1 (includes both the Base and |
| | Card Electromechanical 1.1 specification documents) |
| NR16 | PCI Local Bus Specification, Rev 3.0 |
| NR14 | PCI-to-PCI Bridge Specification 1.2 |
| NR13 | Mobile Design Specification Guide 1.1 |
| NR11 | Power Management Interface Specification 1.2 |
| NR12 | PCI Hot Plug Specification 1.1 |
| NR23 | Standard Hot Plug Controller Specification 1.0 |
| NR9 | PCI BIOS Specification 2.1 |
| NR15 | PCI-X Specification 1.0b |
| NR10 | Mini PCI Specification 1.0 |

Non-limiting examples of connectors that provide signal coupling compatible with the PCI-Express standard include connectors compatible with the MXM format established by Nvidia to house GPUs in a small form-factor (such as for laptops), as well signaling and connectors compatible with AXIOM, a similar small form-factor format established by ATI (albeit, one that is incompatible with MXM). Further and, perhaps, more predominant examples include connectors that—in addition to providing signal coupling that is compatible with the PCI-Express standard—provide mechanical coupling in accord with that standard. Such connectors are readily available throughout the marketplace.

The graphics board slot 18 of a conventional motherboard 12 is typically intended and used to receive a PCI-Express-compatible GPU. Regardless of that intent (or the absence thereof), the illustrated embodiment capitalizes on the presence of such a slot to extend connectivity of the motherboard 12 to multiple GPUs.

To this end, digital data processor 10 includes a graphics interface device 22 comprising printed circuit board 24 having disposed thereon graphics board slots 26a-26d, bridge/switching devices 28a-28c, and connector 30, as shown. The interface device 22 may include other elements, as well, e.g., a power supply (not shown) for powering GPUs or other devices inserted in the slots 26a-26d (e.g., in instances where sufficient power for those GPUs or other devices cannot be drawn from slot 18, itself). In the illustrated embodiment, the device 22 is configured as a daughtercard, though it may take other form factors in other embodiments.

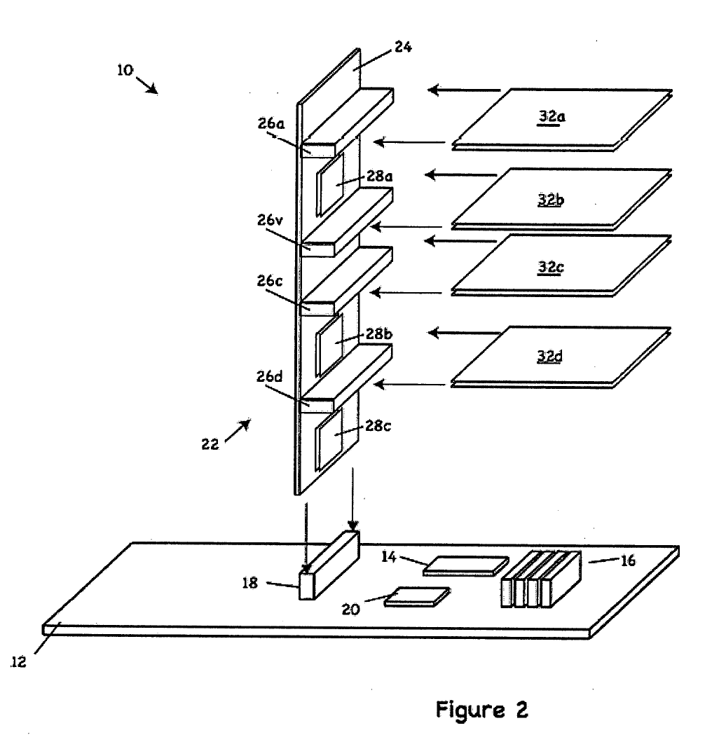

The configuration of FIG. 1 has that daughtercard 22 disposed substantially parallel to the motherboard 12, when the daughtercard is mounted in the slot 18. An alternate embodiment, shown in FIG. 2, has the daughtercard 22 disposed substantially normal to the motherboard 12 (and graphics processing units that are, themselves, mounted in the daughtercard substantially parallel to the motherboard), when the daughtercard is so mounted. Like elements of FIGS. 1 and 2 are labeled with like reference numerals.

Although the illustrated embodiment utilizes conventional printed circuit board substrate 24 for interface device 22, other medium or devices sufficient to support elements 26-30 and their operations in accord herewith can be used instead or in addition. By way of non-limiting example, connector 30 can be disposed on a connector cable and/or a flexible circuit board substrate for coupling to a rigid circuit board substrate on which elements 26-28 are mounted.

Graphics board slots 26a-26d each comprise a connector (e.g., a card edge socket) of the type conventional to, or otherwise known in, the art that is adapted to provide signal coupling in compatible with the PCI-Express industry standard. As with the connector of slot 18, those of slots 26a-26d can include, by way of non-limiting example, connectors compatible with the MXM format of Nvidia, connectors compatible with the corresponding small form-factor format of ATI, and/or connectors that provide both signal and mechanical coupling in accord with the PCI-Express standard.

In the illustrated embodiment, the connectors of slots 26a-26d receive one or more GPUs 32a-32d of the type known and/or commonly used in that art that are compatible with the PCI-Express standard. Though four such GPUs 32a-32d and corresponding slots 26a-26d are shown in the drawing, it will be appreciated that additional (or fewer) slots and/or GPUs may be utilized in other embodiments. Moreover, it will be appreciated that not all of the slots need have GPUs mounted in them for operation of the digital data processor 10.

Connector 30, too, comprises a connector of the type conventional to, or otherwise known in, the art that is adapted to provide signal coupling compatible with the PCI-Express industry standard. Illustrated connector 30 provides mechanical and signal coupling between the daughtercard 22 and slot 18 of the motherboard; hence, its form factor complements that of slot 18. Since the latter (slot 18) is a card edge socket, in the illustrated embodiment, the former is a card edge-type connector. (No additional connector 30 is shown in FIG. 2, since the edge of the board 24 is, itself, etched to provide the necessary coupling).

Bridge/switching devices 28a-28c comprises any bridge device or switching device known and/or commonly used in the art to support bridging and/or switching of signals compatible with the PCI-Express industry standard. Though bridges or switches may be used, the term “switches” is used for convenience in the discussion that follows. Three bridges 28a-28c are shown in the drawing, though other embodiments may use more or less of these devices, depending on switching requirements, consistent with the discussion below.

To understand the role of those switches 28a-28c, it will be appreciated that graphics slot of a conventional motherboard typically provides mechanical and signal coupling for large number of PCI-Express channels or “lanes.” Each of these channels is a separate respective point-to-point serial connection and, in the prior art, is used to support communications between a GPU (or other device) that is inserted in the graphics slot and the processor, its associated memories and/or other components on the motherboard.

In the illustrated embodiment, daughtercard 22 bridges or splits signaling to/from the single GPU slot 18 on the motherboard 12 into multiple slots on the daughtercard and, hence, supports communications between GPUs (or other elements) in slots 26a-26d on that daughtercard and processor 14, its associated memory 16 and/or other components 20 on the motherboard 12. While each of the slots 26a-26d may comprise PCI-Express connectors sized to physically accommodate the same number of channels as slot 18 (or, put another way, of sufficient width to accommodate the same number of conductor sets as necessary to support those channels), slots 26a-26d provide signal coupling (or “electrical coupling,” as referred to below) for different respective subsets of those channels.

To illustrate with a concrete example, in one exemplary embodiment, motherboard 12 provides a single sixteen-lane (16x) PCI-Express slot 18. That slot 18 is both 16x electrically (i.e., it supports signal coupling on sixteen PCI-Express lanes) and 16x physically (i.e., it is sized to accommodate 16x conductors sets). Slots 26a-26d are not necessarily similarly sized. In the illustrated embodiment, they are 16x, physically, and, therefore, support insertion of PCI-Express-compatible GPUs currently available in the marketplace (though, they could be physically sized otherwise). However, slots 26a-26d of the illustrated embodiment are less then 16x electrically. That is, they can support signal coupling with fewer than 16x PCI-Express lanes. This is because PCI-Express-compatible graphics cards 32a-32d can function with signaling on fewer PCI-Express lanes then they support physically. Thus, slots 26a-26d can support 8x, 4x and 1x electrical (or signal) coupling.

As a consequence, to continue the example, daughtercard 22 can be arranged in any variety of configurations to bridge or split signaling to/from the single 16x GPU slot 18 on the motherboard 12 and the slots 26a-26d on the daughtercard. Those configurations include, by way of example, dual 8x, where two of the slots, e.g., 26a, 26c, are configured for signal coupling on 8x lanes; quad 4x, where all four slots 26a-26d are configured for signal coupling on 4x lanes; eight 2x, where eight slots (only four of which are shown) are configured for signal coupling on 2x lanes; or even sixteen 1x, where sixteen slots (again, only four of which are shown) are configured for signal coupling on 1x lanes. These examples are balanced configurations: the daughtercard 22 can also support unbalanced configurations, e.g., where some active slots are coupled to more lanes than others, e.g., one 8x and dual 4x (or, less succinctly, where one slot, e.g., 26a is configured for signal coupling on one 8x lane and two slots, e.g., 26b, 26c, are configured for signal coupling on 4x lanes, each).

In the illustrated embodiment, signal routing necessary to support these and other configurations can be effected by switches 28a-28c, e.g., which route signals between slot 18 (and connector 30, which is coupled thereto) and the slots 26a-26d in accord with the respective subsets of channels assigned to those slots 26a-26d in the desired configuration.

Depending on the functionality of the motherboard chipset, such bridge/switching devices 28a-28c may not be required: some configurations may be realizable with simple passive routing. In such embodiments, PCI-Express signal coupling to/from the slots 26a-26c is supported by direct electrical signal pathways (and without assistance of bridge/switching devices 28a-28c), e.g., over wiring, pins, solder pads and/or printed circuit board conductive vias disposed on and in the substrate 24 and coupling connector 30 to slots 26a-26c in the convention manner, as adapted in accord with the teachings hereof.

Further embodiments of the invention combine splitting (as described immediately above) and switching (as described earlier) in order to create a digital data processor that matches both the number of GPUs and bandwidth to them to a particular set of algorithmic requirements.

As noted above, while the embodiments described herein utilize a single graphics card slot 18, the teachings hereof are applicable to motherboards 12 with more such slots. Those additional slots (and the accompanying PCI-Express lanes) can be used in the manner described above (e.g., with their own associated daughtercards) and/or as I/O to the daughtercard 22 for supporting additional bandwidth to the GPUs 32a-32d attached thereto. For example, a motherboard with dual 1x and a single 16x slots could support a daughtercard with eighteen 1x slots.

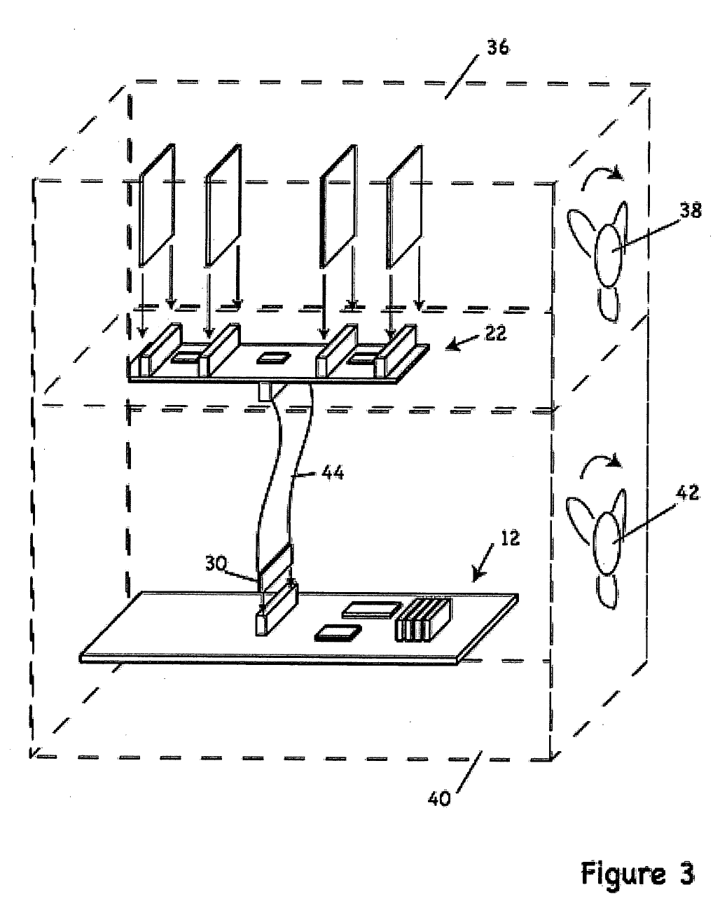

Due to the large amount of power required for multiple graphics cards 32a-32d (and, thus, the attendant excess heat generated by them), some embodiments have the daughtercard 22 and cards 32a-32d housed and/or cooled separately from the motherboard 12. FIG. 3 depicts such an embodiment. In this case, the daughtercard 22 is housed in chassis or chassis portion 36 and cooled by fan 38, while motherboard 12 is housed in chassis or chassis portion 40 and cooled by fan 42. Chassis and fan elements 36-42 are constructed and/or operated in the conventional manner known in the art. In this embodiment, connector 30 is disposed on connector cable 44, flexible circuit board substrate, or otherwise, as shown, in order to provide the necessary signal coupling between the boards 12, 22 and their constituent components.

It will be appreciated that digital data processing apparatus and daughtercards as illustrated here and otherwise in accord with the invention have advantages over the prior art. These include:

1) Smaller form factor. Rather than a 1:1 ratio of host motherboards to GPU cards, a much higher ratio of GPUs to hosts can be built, saving the size of multiple motherboards.

2) Less cost. As with #1, the cost of the system is significantly less.

3) Very high interconnect bandwidth. Rather than using some inter-motherboard interconnect (Infiniband, gigabit Ethernet etc.) and their inherent bandwidth limitations, the GPU card's very high speed native interconnect (like PCI-Express) is employed to transfer the data.

4) Leverage of commodity devices. This daughter card approach permits rapid deployment of different motherboards and graphics boards since it is specific to the interconnect bus only.

5) Simplicity of construction. Rather than requiring the modification of a complex motherboard, a relatively simple daughtercard is constructed.

6) Flexibility of configuration. This approach permits mixing and matching motherboards with various processor configurations with various daughtercards to achieve an optimal GPU to host processor ratio for a given algorithm.

Disclosed above are systems, devices and methods of operation meeting the objects set forth previously. It will be appreciated that the embodiments illustrated and described here are merely examples of the invention and that other embodiments, incorporating changes thereto, fall within the scope of the invention. Thus, for example, it will be appreciated that although the illustrated embodiment utilizes the daughtercard (or graphics interface device) 22 to bridge or split signaling between a slot on a motherboard, for example, and a plurality of GPU cards, it may also be used to bridge or split signaling between a motherboard slot and other devices compatible with the PCI-Express standard.

1. A digital data processor, comprising:
A. a motherboard including a printed circuit board having disposed thereon
(i) a central processing unit and one or more associated memories, and
(ii) a primary slot adapted to provide signal coupling compatible with the PCI-Express industry standard,
B. a graphics interface device that is mounted in the primary slot and that is in mechanical and signal coupling with the motherboard, and
C. the graphics interface device having a plurality of further slots, each of which is adapted to provide signal coupling compatible with the PCI-express industry standard.

2. The digital data processor of claim 1, in which at least one graphics device is mounted in, and in mechanical and signal coupling with, a respective one of the further slots on the graphics interface device.

3. The digital data processor of claim 1, in which a plurality of graphics devices are mounted in, and in mechanical and signal coupling with, respective ones of the further slots on the graphics interface device.

4. The digital data processor of claim 3, in which one or more of the graphics devices are graphics processing units (GPUs).

5. The digital data processor of claim 4, wherein the primary slot, in which the graphics interface device is mounted, is intended for mounting of a single GPU.

6. The digital data processor of claim 1 in which the graphics interface device comprises a daughtercard, which includes a printed circuit board on which the further slots are disposed.

7. The digital data processor of claim 6, in which the daughtercard, when mounted in the primary slot, is disposed substantially parallel to the motherboard.

8. The digital data processor of claim 6, in which the daughtercard is disposed substantially normal to the motherboard and the graphics devices are disposed substantially parallel to the motherboard, when the daughtercard is mounted in the primary slot and the graphics devices are mounted in the daughtercard.

9. The digital data processor of claim 1, wherein
A. one or more graphics devices are mounted in, and in mechanical and signal coupling with, respective ones of the further slots on the graphics interface device, and
B. those graphics devices are housed and/or cooled separately from the motherboard.

10. A digital data processor, comprising:
A. a motherboard including a printed circuit board having disposed thereon
(i) a central processing unit and one or more associated memories, and
(ii) a primary slot adapted to provide signal coupling compatible with the PCI-Express industry standard,
the primary slot providing signal coupling over N channels, each providing a separate respective point-to-point serial connection between the motherboard and the graphics interface device,
the primary slot providing mechanical coupling sufficiently sized for N corresponding conductor sets, each providing an electrical signaling pathway for the serial connection of a respective one of the N channels,
B. a graphics interface device that is mounted in the primary slot and that is in mechanical and signal coupling with the motherboard, and
C. the graphics interface device having a plurality of further slots, each of which is adapted to provide signal coupling compatible with the PCI-Express industry standard.

11. The digital data processor of claim 10, in which at least one of the N channels provides a two-way serial connection between the graphics interface device and the CPU and/or one of its associated memories.

12. The digital data processor of claim 11, in which the N channels provide N two-way serial connections between the graphics interface device and the CPU and/or one of its associated memories.

13. The digital data processor of claim 10, in which the graphics interface device comprises one or more bridges or switches (collectively, “switches”) that provide signal coupling between subsets of the N channels received from the primary slot and respective ones of the further slots.

14. The digital data processor of claim 13, in which the further slots provide mechanical coupling of sufficient width to accommodate all N conductor sets, yet, provide electrical coupling for only the respective subsets of the channels for which signal coupling is provided by the switches.

15. The digital data processor of claim 10, in which signal coupling on the graphics interface device between the primary slot and one or more of the further slots is supported by direct electrical signal pathways for respective subsets of the N channels, where those pathways are free of bridges and/or switches.

16. The digital data processor of claim 15, in which the direct electrical signal pathways comprise electrical wiring, pins, solder pads and/or printed circuit board conductive vias.

17. The digital data processor of claim 16, in which the subsets of channels over which signaling is provided to the further slots are of equal bandwidth.

18. The digital data processor of claim 16, in which the subsets of channels over which signaling is provided to the further slots are of unequal bandwidth.

19. The digital data processor of claim 10, in which at least one graphics device is mounted in, and in mechanical and signal coupling with, a respective one of the further slots on the graphics interface device.

20. The digital data processor of claim 10, in which a plurality of graphics devices are mounted in, and in mechanical and signal coupling with, respective ones of the further slots on the graphics interface device.

21. The digital data processor of claim 20, in which one or more of the graphics devices are graphics processing units (GPUs).

22. The digital data processor of claim 21, wherein the primary slot, in which the graphics interface device is mounted, is intended for mounting of a single GPU.

23. The digital data processor of claim 10 in which the graphics interface device comprises a daughtercard, which includes a printed circuit board on which the further slots are disposed.

24. The digital data processor of claim 23, in which the daughtercard, when mounted in the primary slot, is disposed substantially parallel to the motherboard.

25. The digital data processor of claim 23, in which the daughtercard is disposed substantially normal to the motherboard and the graphics devices are disposed substantially parallel to the motherboard, when the daughtercard is mounted in the primary slot and the graphics devices are mounted in the daughtercard.

26. The digital data processor of claim 10, wherein
A. one or more graphics devices are mounted in, and in mechanical and signal coupling with, respective ones of the further slots on the graphics interface device, and
B. those graphics devices are housed and/or cooled separately from the motherboard.

27. A graphics interface device for use in a digital data processor of the type comprising a printed circuit board having disposed thereon (i) a central processing unit and one or more associated memories, and (ii) a primary slot adapted to provide signal coupling compatible with the PCI-Express industry standard, the graphics interface device comprising
A. a connector for mounting in the primary slot so as to provide mechanical and signal coupling with the motherboard, and
B. a plurality of further slots, each of which is adapted to provide signal coupling compatible with the PCI-Express industry standard.

28. The graphics interface device of claim 27, in which at least one graphics device is mounted in, and in mechanical and signal coupling with, a respective one of the further slots on the graphics interface device.

29. The graphics interface device of claim 27, in which a plurality of graphics devices are mounted in, and in mechanical and signal coupling with, respective ones of the further slots on the graphics interface device.

30. The graphics interface device of claim 29, in which one or more of the graphics devices are graphics processing units (GPUs).

31. The graphics interface device of claim 30 adapted for mounting in a primary slot that is intended for a single GPU.

32. The graphics interface device of claim 27 in the form factor of a daughtercard which includes a printed circuit board on which the further slots are disposed.

33. The graphics interface device of claim 32 configured so that, when mounted in the primary slot, is disposed substantially parallel to the motherboard.

34. The graphics interface device of claim 32, configured so that, when mounted in the primary slot, is disposed substantially normal to the motherboard and the graphics devices are disposed substantially parallel to the motherboard.

35. A graphics interface device for use in a digital data processor of the type comprising a printed circuit board having disposed thereon (i) a central processing unit and one or more associated memories, and (ii) a primary slot adapted to provide signal coupling compatible with the PCI-Express industry standard, the primary slot providing signal coupling over N channels, each providing a separate respective point-to-point serial connection between the motherboard and the graphics interface device, the primary slot providing mechanical coupling sufficiently sized for N corresponding conductor sets, each providing an electrical signaling pathway for the serial connection of a respective one of the N channels, the graphics interface device comprising
A. a connector for mounting in the primary slot so as to provide mechanical and signal coupling with the motherboard, and
B. a plurality of further slots, each of which is adapted to provide signal coupling compatible with the PCI-Express industry standard.

36. The graphics interface device of claim 35, in which at least one of the N-channels provides a two-way serial connection between the graphics interface device and the CPU and/or one of its associated memories.

37. The graphics interface device of claim 36, in which the N channels provide N two-way serial connections between the graphics interface device and the CPU and/or one of its associated memories.

38. The graphics interface device of claim 35 comprising one or more bridges or switches (collectively, “switches”) that provide signal coupling between subsets of the N channels received from the primary slot and respective ones of the further slots.

39. The graphics interface device of claim 38, in which the further slots provide mechanical coupling of sufficient width to accommodate all N conductor sets, yet, provide electrical coupling for only the respective subsets of the channels for which signal coupling is provided by the switches.

40. The graphics interface device of claim 35, in which signal coupling on the graphics interface device between the primary slot and one or more of the further slots is supported by direct electrical signal pathways for respective subsets of the N channels, where those pathways are free of bridges and/or switches.

41. The graphics interface device of claim 40, in which the direct electrical signal pathways comprise electrical wiring, pins, solder pads and/or printed circuit board conductive vias.

42. The graphics interface device of claim 41, in which the subsets of channels over which signaling is provided to the further slots are of equal bandwidth.

43. The graphics interface device of claim 41, in which the subsets of channels over which signaling is provided to the further slots are of unequal bandwidth.

44. The graphics interface device of claim 35, in which at least one graphics device is mounted in, and in mechanical and signal coupling with, a respective one of the further slots on the graphics interface device.

45. The graphics interface device of claim 35, in which a plurality of graphics devices are mounted in, and in mechanical and signal coupling with, respective ones of the further slots on the graphics interface device.

46. The graphics interface device of claim 45, in which one or more of the graphics devices are graphics processing units (GPUs).

47. The graphics interface device of claim 46 adapted for mounting in a primary slot that is intended for a single GPU.

48. The graphics interface device of claim 35 in the form factor of a daughtercard which includes a printed circuit board on which the further slots are disposed.

49. The graphics interface device of claim 48 configured so that, when mounted in the primary slot, is disposed substantially parallel to the motherboard.

50. The graphics interface device of claim 48, configured so that, when mounted in the primary slot, is disposed substantially normal to the motherboard and the graphics devices are disposed substantially parallel to the motherboard.

51. A digital data processor, comprising:
A. a motherboard including a printed circuit board having disposed thereon
(i) a central processing unit and one or more associated memories, and
(ii) a primary slot adapted to provide signal coupling compatible with the PCI-Express industry standard,
B. a graphics interface device that is in signal coupling with the motherboard,
C. the graphics interface device having a plurality of further slots, each of which is adapted to provide signal coupling compatible with the PCI-Express industry standard,
D. one or more graphics devices are mounted in, and in mechanical and signal coupling with, respective ones of the further slots on the graphics interface device, and
E. those graphics devices are housed and/or cooled separately from the motherboard.
